(19) United States
(12) Patent Application Publication
(10) Pub. No.: US 2017/0357923 A1
(43) Pub. Date: Dec. 14, 2017

(54) CONSTRUCTION ANALYTICS TO IMPROVE SAFETY, QUALITY AND PRODUCTIVITY

(71) Applicant: Sundt Construction, Inc., Tempe, AZ (US)

(72) Inventor: Timothy J. Gattie, Tempe, AZ (US)

(21) Appl. No.: 15/619,008

(22) Filed: Jun. 9, 2017

Related U.S. Application Data
(60) Provisional application No. 62/348,679, filed on Jun. 10, 2016.

(51) Int. Cl. G06Q 10/06

(52) U.S. Cl. CPC G06Q 10/0639

(57) ABSTRACT

Construction analytics is a method of objectively evaluating data from past and/or current construction projects to drive decision making to produce favorable outcomes. Specifically, data may be collected and stored for past and/or current construction projects to improve the safety, quality and productivity of future projects. The most common hazards may be predicted when a type of work is repeated and measures may be put into place to prevent the hazards from occurring again by using a data set produced from safety inspections, observations and incidents that are categorized by the type of work being performed. Mitigations may be implemented before performing a work activity and selecting problematic materials on a project by searching a database containing all of the deficiencies and non-conformance issues encountered in the past on the particular feature of work.

### CROSS-REFERENCE TO RELATED APPLICATION

This application claims the benefit of U.S. Provisional Application No. 62/348,679, filed Jun. 10, 2016.

### FIELD OF THE INVENTION

The present invention generally relates to a method of creating and using construction analytics to improve the safety, quality and productivity of a construction company.

### SUMMARY OF THE INVENTION

Construction analytics is a method of objectively evaluating data from past projects to drive decision making to produce favorable outcomes in current and future projects. Specifically, data may be collected and stored in a database for past and/or current construction projects to improve the safety, quality and productivity of current and future projects. The collected and analyzed data may be weather information, parties involved, activities performed, project schedule status, project cost status and/or any combination thereof related to a particular past or future project. The data from past projects may be used to predict hazards for current or future projects.

The most common or likely-to-occur hazards in a construction site may be predicted when a type of work is repeated and measures may be put into place to prevent the hazards from occurring again by using a data set produced from safety inspections, observations and incidents that may be categorized by the type of work being performed.

Following the prediction of an upcoming hazard, mitigations may be implemented before performing a work activity and selecting problematic materials on a project by searching a database containing all of the deficiencies and non-conformance issues encountered in the past on the particular feature of work. Within a construction site, craft people may be better prepared to be safe and productive at each and every activity they perform by preparing a comprehensive work plan package containing safety and quality findings.

In order to capitalize on these potential benefits, standard operating procedures may be changed and enhancements added.

In accordance with the present disclosure, a software system may be used to collect data from inspections. As described herein, the data may describe various activities that have occurred or are occurring on one or more construction sites. The data may include description of hazards that have occurred (e.g., accidents or potential accidents) or successful completion of work projects. This same software package may analyze the collected data to generate reports and dashboard features needed to track performance of projects and anticipate potential hazards and issues associated with specific tasks.

Information regarding individuals, such as employees of the construction company and its subcontractors, may also be tracked. As non-limiting examples, the individuals involved with each observation and incident and their specific actions may be recorded and saved in a database for later use and analysis. In addition, consumer information for every individual may be collected (possibly collected from online data sources), saved in a database and used in later analysis. Collecting information on the individual employees may be used to identify top performers for honors, awards and recognition as well as in identifying employees that have a history of incident reports or problems that may need additional supervision and/or training.

Using the present system, work planning may be enhanced. By implementing a work planning package that provides a complete package of information, the invention may ensure that craft people have everything they need to be safe and productive without encountering costly quality issues. Furthermore, using the present system, a culture may be created of employees inspecting their own work for both safety hazards and quality issues. This may include promoting the collection of information on near misses and very minor incidents from these employees. The information from these inspections and observations may become the backbone of the Construction Analytics system. This may be accomplished through a series of training modules and reward programs.

By fully implementing these enhancements, safety, quality and productivity goals may be achieved within a number of different environments. As non-limiting examples, OSHA rates may be lowered, re-work time may be lowered and improved productivity of craft employees may be increased.

By implementing the safety and quality portions of the construction analytics, productivity may increase solely as a result of the craft personnel time saved by not having to stop to review the number of eliminated safety incidents and quality deficiencies.

The above features and advantages of the present invention will be better understood from the following detailed description taken in conjunction with the accompanying drawings.

### BRIEF DESCRIPTION OF THE DRAWINGS

FIG. 1 is a flowchart for a system overview.

FIG. 2 illustrates non-limiting examples of working conditions.

FIG. 3 illustrates non-limiting examples of activity data.

FIG. 4 illustrates non-limiting examples of worker data.

FIG. 5 illustrates non-limiting examples of behavior data.

FIG. 6 illustrates non-limiting examples of incident data.

FIG. 7 illustrates a non-limiting example of a flowchart for employee orientation record collection.

FIG. 8 illustrates a non-limiting example of a flowchart for inspection data collection.

FIG. 9 illustrates a non-limiting example of a flowchart for incident data collection.

FIG. 10 illustrates a non-limiting example of a flowchart for predictive activity capture process.

FIG. 11 illustrates a non-limiting example of a flowchart for predictive meeting agenda creation.

FIG. 12 illustrates a non-limiting example of a flowchart for a safety meeting record collection.

FIG. 13 illustrates a non-limiting example of a flowchart for an employee training record collection.

FIGS. 14 and 15 illustrate a non-limiting example of a flowchart of a process for improving the safety of an upcoming activity for a construction company.

FIGS. 16 and 17 illustrate a non-limiting example of a flowchart of a process for improving the safety of an upcoming activity for a construction company.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

### System Description

The present Construction Analytics System (CAS) may enable construction companies to use data from previous or ongoing projects to better plan work and to prevent safety and quality incidents. At its core, the CAS is a database of observations and incidents (both from safety and quality) that may be populated through a set of electronic forms used to perform inspections.

From an Operations Management viewpoint, the CAS may provide real-time tracking of inspections (from both safety and quality personnel) which may be viewed in both live reports and from a dashboard on an internal company website. Information may be viewed in both report and dashboard formats. In addition, information may be made available to help Operations Management staff identify projects and even individuals who might need more attention.

At the craft level, the CAS may be the center of a cultural shift in the construction company. The construction company may develop a culture of self-inspection, one that encourages the identification of safety hazards and quality issues before the issues manifest into costly, time-consuming safety and quality incidents. Crews may work with field inspection staff to identify these items and record them in the CAS with the goal of preventing the issues from happening on future projects.

GOALS OF CONSTRUCTION ANALYTICS—By fully implementing the CAS, the construction company's safety, quality and productivity may be improved.

Generally, the CAS operates by collecting data describing activities within a construction site, such as the occurrence of hazards (either resulting in an injury to an employee, damage to equipment or the worksite and/or creating a dangerous situation to employees, equipment and/or the worksite). The data describing a particular hazard may include an identification of the individual involved in the hazard, the location of the hazard, particular crafts involved with the hazard, standardized work activity codes associated with the tasks being undertaken when the hazard occurred, a time and date of the hazard, a type of weather that was prevalent at the location and time of the hazard, and the consequences or results of the hazard. The CAS may also collect the same or similar information about successfully completed work projects

With the data describing the hazards and, optionally, successfully completed projects, collected, the CAS can then execute one or more analytical routines to analyze the collected data to make predictions about potential hazards that are likely to occur in current or future projects, tasks or activities.

For example, if the collected data shows that a particular type of task that involves a particular group of people has resulted in a number of hazards with serious consequences (e.g., injury), the CAS can analyze upcoming task assignment to see if that same group of people have been assigned that same task in the future. If that is the case, the CAS may predict that the hazard is likely to occur again. With such a prediction made, the CAS can notify suitable personnel of the risk of the upcoming hazard. At that time the CAS can suggest potential remediation measures, such as a providing the individuals supplemental training on their assigned task to reduce the likelihood of a hazard. In other instances, the CAS may recommend that other individuals, possibly with more experience and/or a history of fewer hazards when performing the task, be assigned to perform the task instead.

In some instances, the historical data may show that particular hazards are more likely to occur in a particular set of circumstances than others. For example, some hazards may be more likely to occur in inclement weather (e.g., rain or snow). In that case, for tasks in which the likelihood of a hazard occurring is associated with a particular weather condition, the CAS can analyze upcoming weather forecasts to identify upcoming tasks that may have higher risks of hazards given the upcoming weather forecast. For example, if a particular task is schedule for completion during a forecasted rain storm and that task has a history of hazards associated with rain storms, the CAS may predict that the task will result in a hazard. In that case the CAS may also provide suggested remediation activities such as rescheduling the task to a time when better weather has been forecasted, re-assigning the task to other individuals with a reduced history of the hazard, or providing additional training to reduce the likelihood of the hazard occurring. In a similar manner, some tasks may have a higher likelihood of hazards occurring should the task be schedule for completion at the end of the day (e.g., when workers are fatigued or potentially rushed). Again, in that case, the CAS can suggest a number of potential mitigating or corrective actions including rescheduling, reassigning, or providing additional training to the assigned individuals.

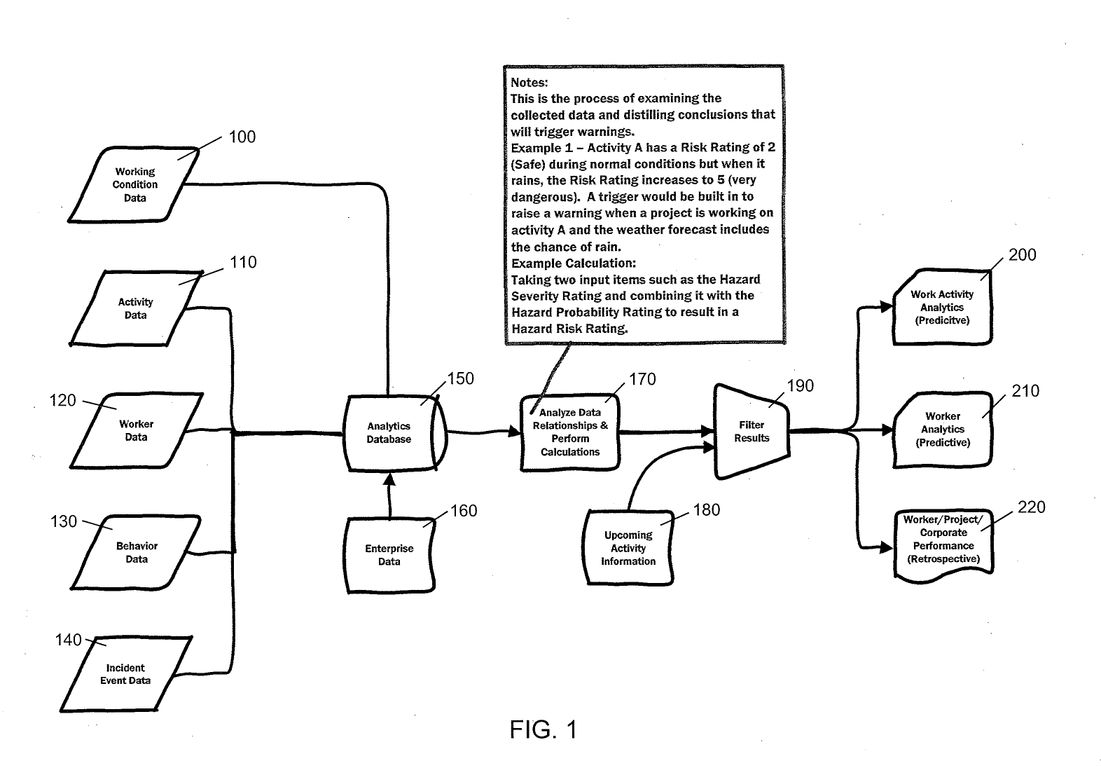

To illustrate the present CAS, FIG. 1 is a block diagram illustrating a potential system layout for the CAS. Referring to FIG. 1, the CAS is configured to collect, as non-limiting examples, working condition data 100, activity data 110, worker data 120, behavior data 130 and/or incident event data 140. The data may be collected from inspection and incident reports and from weather application program interfaces (APIs). Some of the data can be retrieved from one or more production management databases in communication with the CAS. Such production management databases may store project scheduling and task assignments, human resources data describing one or more attributes of each potential assigned individual, and the like.

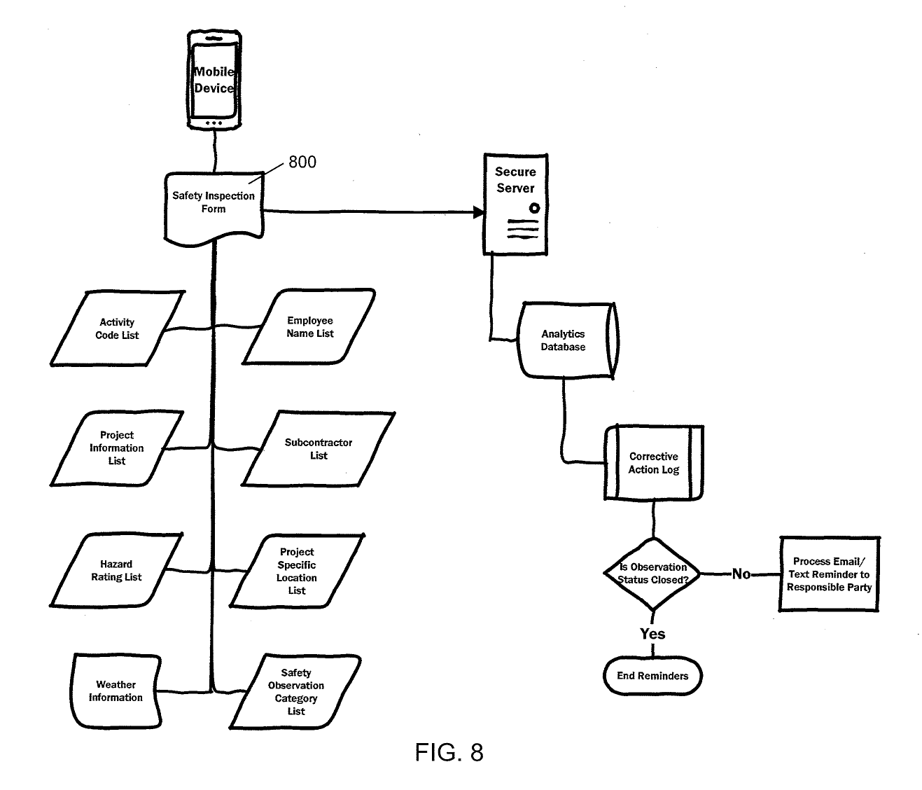

In various embodiments, the inspection and incident reports can be collected via data inputted by one or more inspectors into portable computing devices, such as tablets or smartphones. Once the data is collected, the data can be communicated to the CAS via any suitable data transfer medium, such as wireless network or cellular data connection. To illustrate, FIG. 8 depicts a process for an inspector to complete a safety inspection form 800 using a mobile device, where the data entered into that safety inspection form 800 may be stored in an analytics database on a secure server. The safety inspection form 800 is preferably created after every safety inspection. The safety inspection form 800 may comprise a standardized work activity code list, employee name list, project information list, subcontractor list, hazard rating list, project specific location list, weather information and safety observation category list.

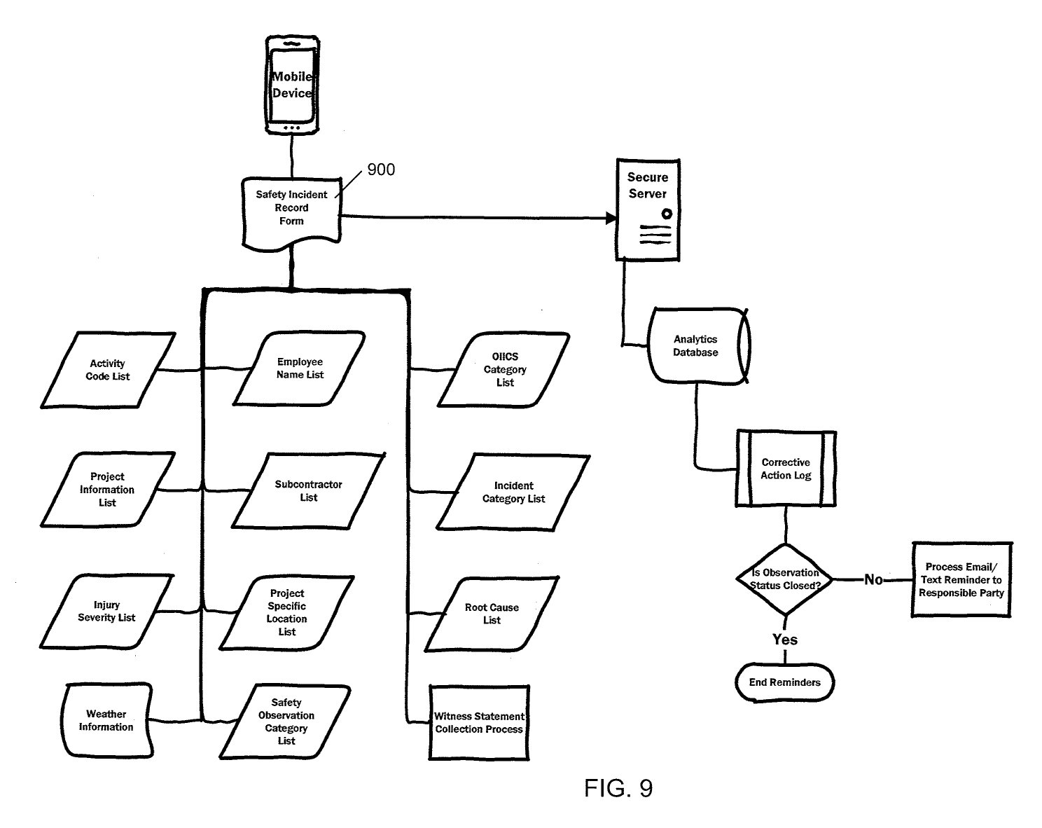

In a similar manner, an inspector may complete a safety incident report. For example, referring to FIG. 9, a safety incident record form 900 may also be completed by an inspector using a portable computing device and stored in the analytics database on the secure server. The safety incident record form 900 is preferably created after every safety incident, i.e., whenever an injury or dangerous situation is found. The safety incident form may comprise a standardized work activity code list, employee name list, project information list, subcontractor list, injury severity list, project specific location list, weather information, safety observation category list, Occupational Injury and Illness Classification System (OIICS) category list, incident category list, root cause list and collected witness statements.

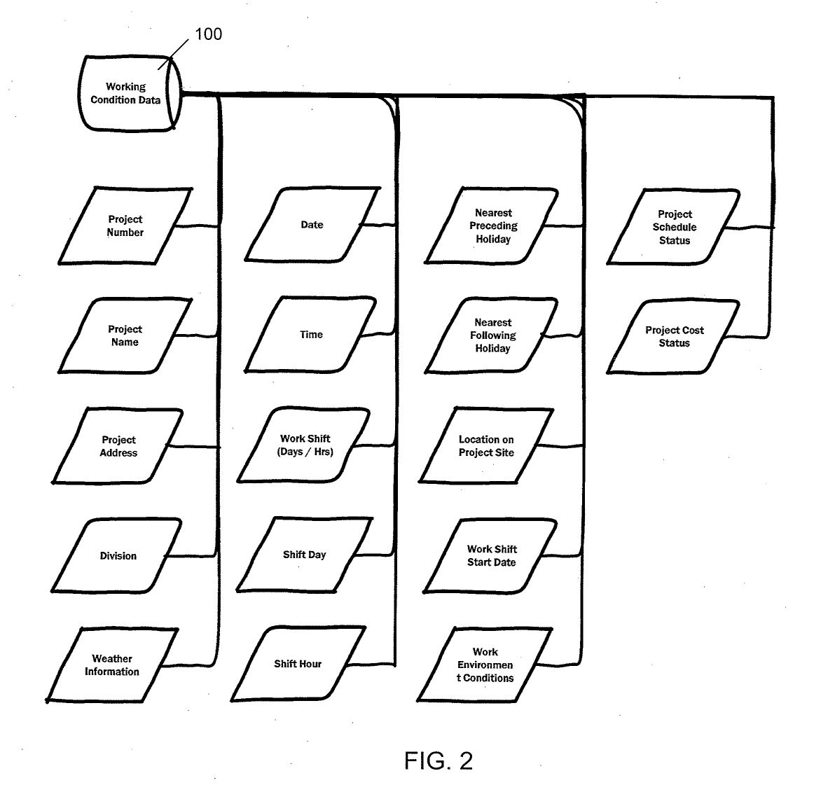

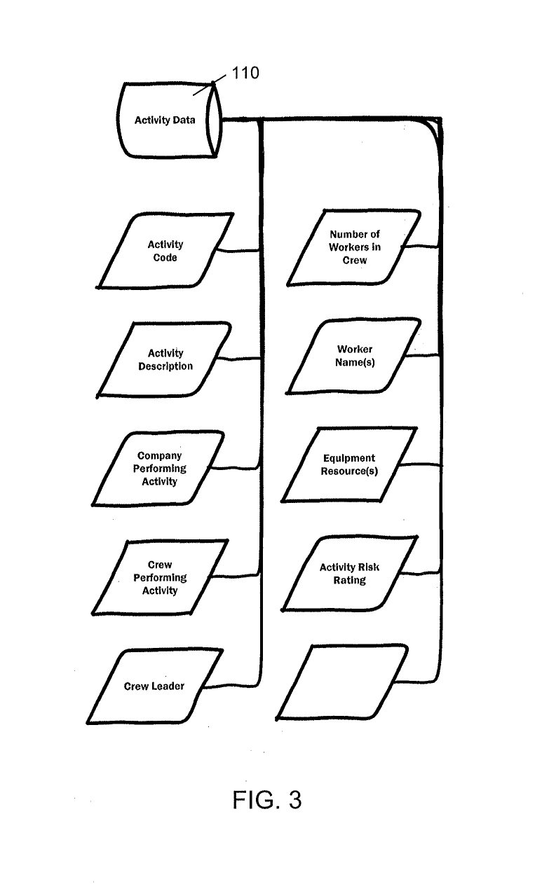

As shown in FIG. 2, the working condition data 100 may include a project number, project name, project address, division, weather information, date, time, work shift (days/hours), shift day, shift hour, nearest proceeding holiday, nearest following holiday, in the crew worker name(s), equipment resource(s) and/or activity risk rating.

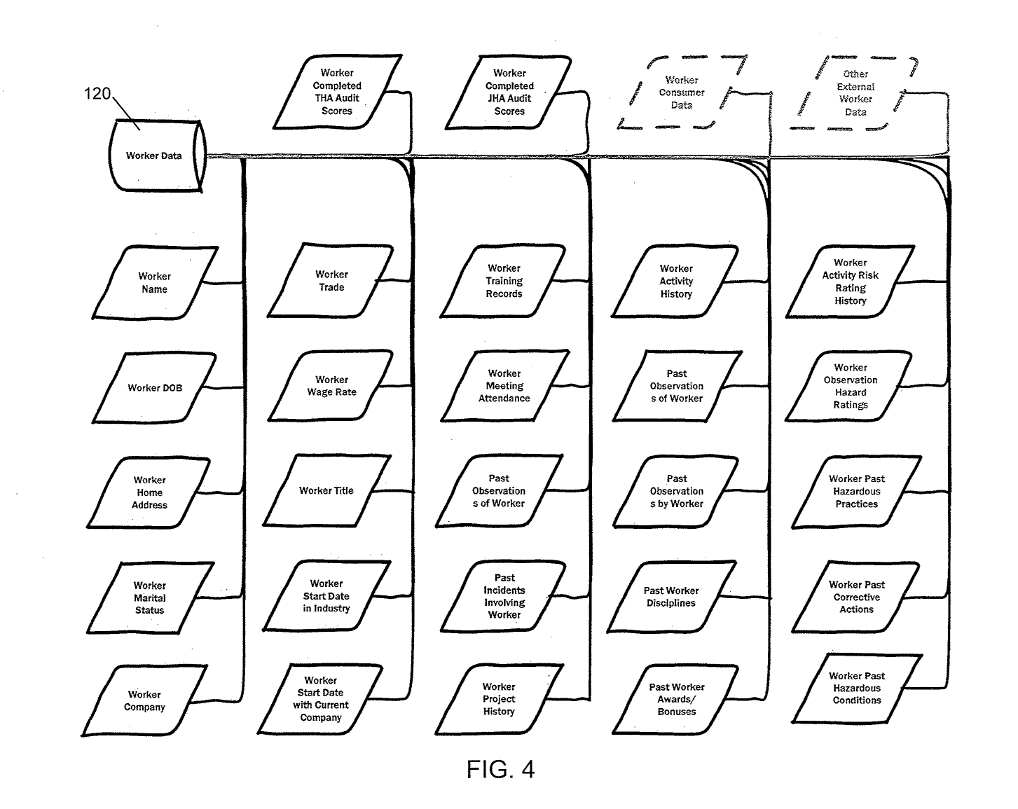

As shown in FIG. 4, the worker data 120 may include a worker name, worker date of birth, worker home address, worker company, worker trade, worker wage rate, worker title, worker start date in industry, worker start date with the company, worker training records, worker meeting attendance, past observation(s) of the worker, past incidents involving the worker, worker project history, worker activity history, past worker disciplines, past worker awards/bonuses, worker activity risk rating history, worker observation hazard ratings, worker past corrective actions and/or worker past hazardous conditions. The worker data may be collected from, as non-limiting examples, worker completed THA audit scores, worker completed JHA audit scores, worker's consumer data found from online data sources and/or other external worker data. The worker data 120 may be collected for each worker in a plurality of workers.

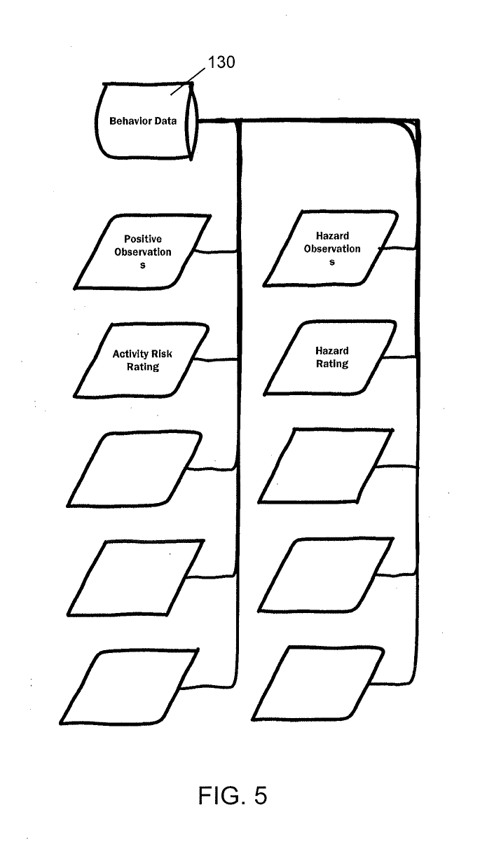

As shown in FIG. 5, the behavior data 130 may include positive observations, activity risk ratings, hazard observations and hazard rating.

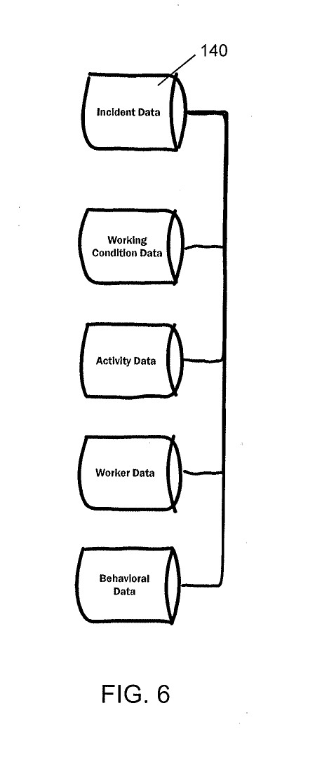

As shown in FIG. 6, the incident data may include working condition data, activity data, worker data and behavioral data.

The data collected by the CAS may also include, as non-limiting examples, a list of activities and projects performed, the parties involved (who they work for, i.e., the construction company or a name of a third party), the weather, the project schedule status and/or the project cost status for each project. The data may be collected by supervisors and/or by the employees performing the activities. Enterprise data 160 may also be collected by the construction company.

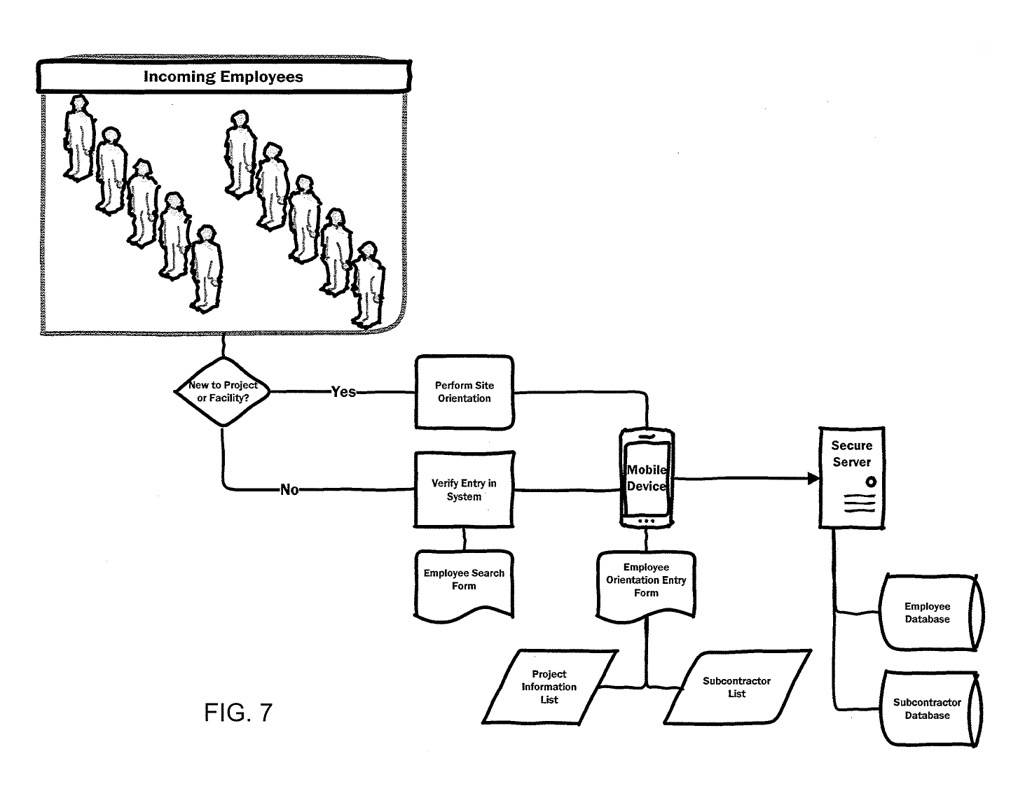

As part of the data collection, when a new employee becomes eligible to work on tasks, data describing that employee can be collected by the CAS or a human resources system in communication with the CAS. As such, FIG. 7 depicts a process for collecting data describing incoming employees. The process allows the data to be collected from a mobile device that stores the data in an analytics database in communication with the CAS. The analytics database may further comprise an employee database and a subcontractor database. New employees to a project or facility may be required to perform a site orientation.

Having collected data describing a number of employees (e.g., individuals that may be assigned to one or more tasks), as well as data captured via a number of safety inspection reports and safety incident reports, the CAS can execute an analytic engine to analyze the captured data in order to predict upcoming or potential hazards. The analytic engine may be of any desired type. As non-limiting examples, the analytic engine may use machine learning, such as supervised learning, unsupervised learning or reinforcement learning. The information and data from past activities may also be used to train an artificial intelligence network, which, after being trained, may use data from upcoming tasks or activities to predict one or more hazards for the upcoming tasks or activities.

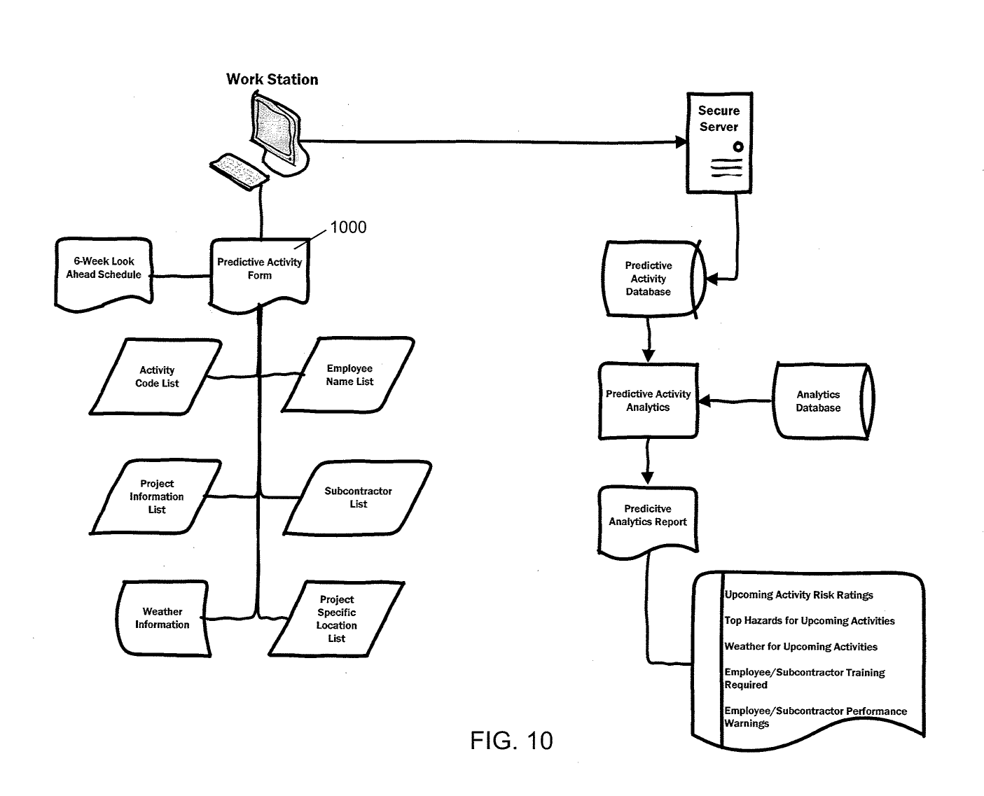

In a first step in such a process, the CAS identifies a number of upcoming tasks or activities. The listing of upcoming tasks or activities may be limited to a particular site or be associated with a particular individual. Or, alternatively, the listing may include all upcoming tasks or activities. To illustrated, FIG. 10 is a flowchart depicting an example process for generating a predictive activity form 1000 regarding a future or a current work activity or project. The predictive activity form 1000 may include a look ahead schedule. The amount of look ahead time may be selected as desired. In a preferred embodiment, a 6 week look ahead schedule is provided as part of the predictive activity form 1000. The predictive activity form 1000 may also include a standardized work activity code list for each activity or project anticipated to be worked on, an employee name list of employees anticipated to work on the activity or project, a project information list, a subcontractor list, weather information and a project specific location list.

After a number of upcoming tasks or activities have been identified pursuant to the method illustrated in FIG. 10, the predictive activity form 1000 may be transmitted to a secure server and stored in a predictive activity database. An analytics engine may then run predictive activity analytics on data from the predictive activity database and the analytics database to produce a predictive analytics report which may comprise upcoming activity risk ratings, top hazards for upcoming activities, weather for upcoming activities, employee/subcontractor training required and employee/subcontractor performance warnings.

The collected data (past data) may be stored in an analytics database 150. The analytics database 150 may be any type of electronic hardware database suitable for storing data for years at a time that may be easily accessed by a computer running software.

Returning to FIG. 1, an analytics engine may examine the data stored in the analytics database to determine patterns, correlations and/or causations at Step 170 in order to create and trigger warnings of potential upcoming hazards. As an example, if activity A has a Risk Rating of 2 (safe) during normal conditions, but when it rains the Risk Rating is 5 (very dangerous), a trigger may be built into the software to raise a warning when a project is working on activity A and the weather forecast includes the chance of rain.

The construction company may perform activities and projects 180 in the course of performing its business. These current activities and projects 180 may be similar to past activities and projects. Specifically, the current activities and projects 180 may have, as non-limiting examples, similar or overlapping working conditions, activities and projects, workers, project schedule status, project cost status and/or weather conditions. In preferred embodiments, the data regarding the current activities and projects 180 is collected at least several weeks (and preferably at least six weeks) prior to starting the current activities and projects 180 to allow time for corrective or mitigating actions to be taken if needed.

The analytics engine may receive the information on the current activities and projects 180 and filter the results at step 190. The analytics engine may receive weather reports from one or more weather information sources. In preferred embodiments, the analytics engine is able to receive weather information over the Internet from the one or more weather information sources using any desired protocol. As a non-limiting example, the analytics engine may obtain weather information from one or more weather information sources via a Rich Site Summary (RSS) feed. The analytics engine may extrapolate the data from the past activities and projects, as well as using any created triggers, to produce a report. The report may comprise a list of hazards and for each hazard in the list of hazards a level of risk associated with the hazard. As specific examples, the report may include a work activity analytics (predictive) 200 for any activities or projects that are determined to be unsafe or require mitigating actions. The report may also include a worker analytics (predictive) 210 indicating whether any particular workers need special training, additional supervision or a substitution with another employee with a better safety record for the activity or project. The report may also include a worker/project/corporate performance (retrospective) 220 indicating expected performance of the current activities and projects based on the performance of past activities and projects. In addition, the construction company may use the disclosed process before submitting a bid for a new project to predict how risky the activities and projects are for the new project. The construction company may then adjust their bid or not submit a bid if the new project represents a particularly risky endeavor based on the risk analysis of the new project.

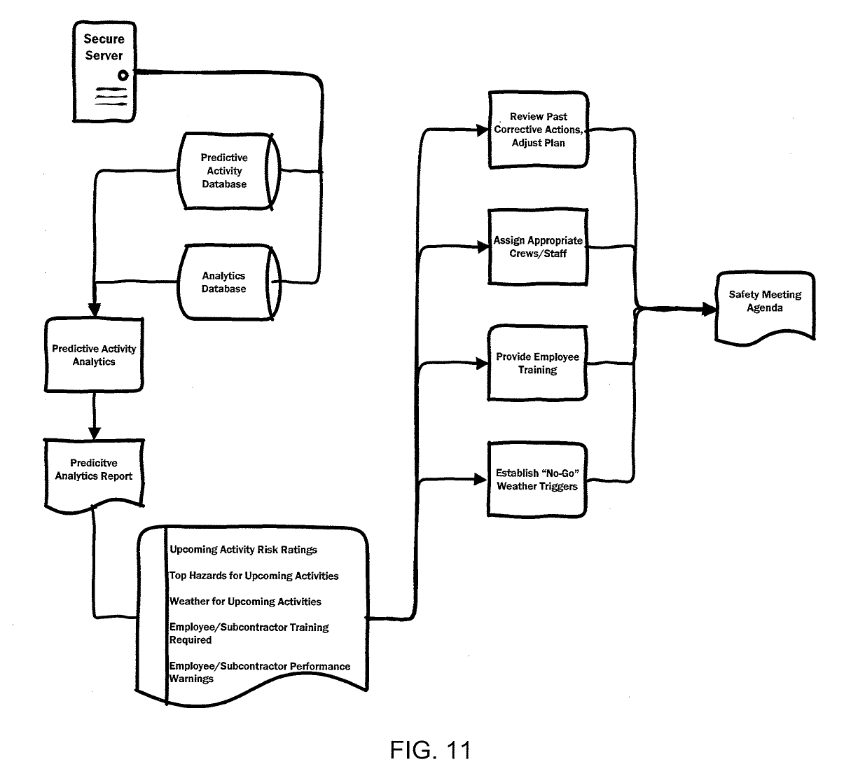

The construction company, using the report, may then take mitigation actions to reduce the level of risk associated with one or more hazards and employees in the list of hazards and employees. Referring to FIG. 11, the predictive analytics report may be used to review past corrective actions and adjust mitigation plans accordingly. The construction company may assign appropriate crews and staff to mitigate any hazards or triggers found in the predictive analytics report. The construction company may provide employee training to mitigate potential hazards predicted by the system. The construction company can establish “no-go” weather triggers that would stop employees from performing certain activities or projects based on the current weather. These various mitigation activities are preferably discussed as part of an agenda at a safety meeting.

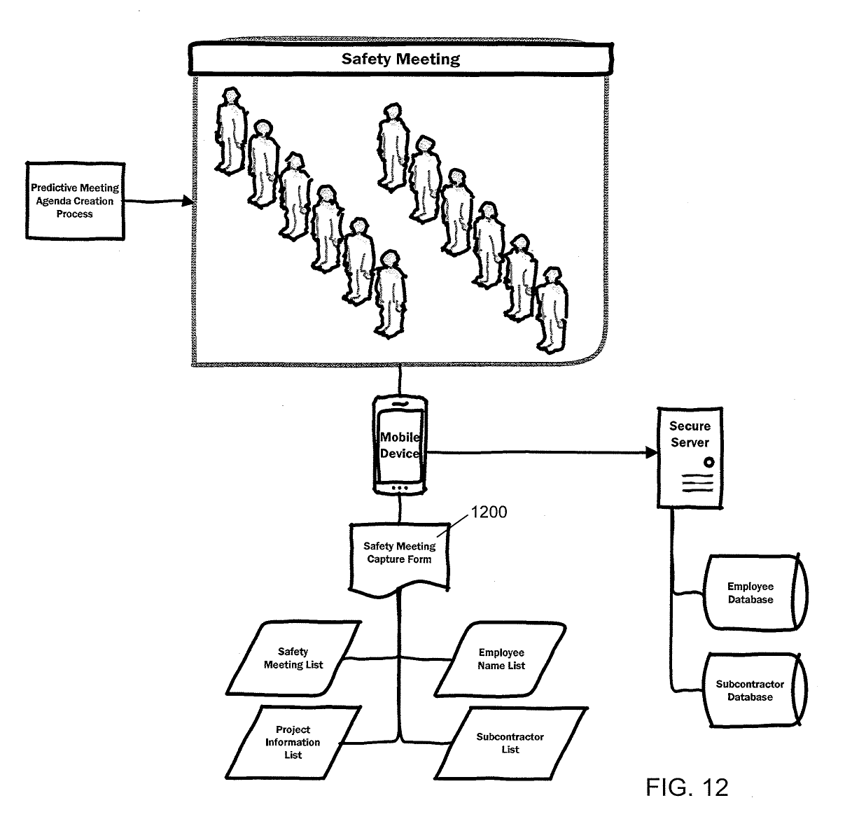

FIG. 12 illustrates the activities that may be performed by employees at a safety meeting. The safety meeting employees may review the safety meeting agenda created by the analytics engine and make plans to take mitigating actions to reduce or eliminate as many of the identified hazards as possible, such as not perform certain work in certain conditions, require additional training for certain employees and/or add additional safety staff/employees on activities and projects identified as being risky. A safety meeting capture form 1200, comprising a safety meeting list, employee name list, project information list and subcontractor list may be created and stored for later use and analysis by the analytics engine.

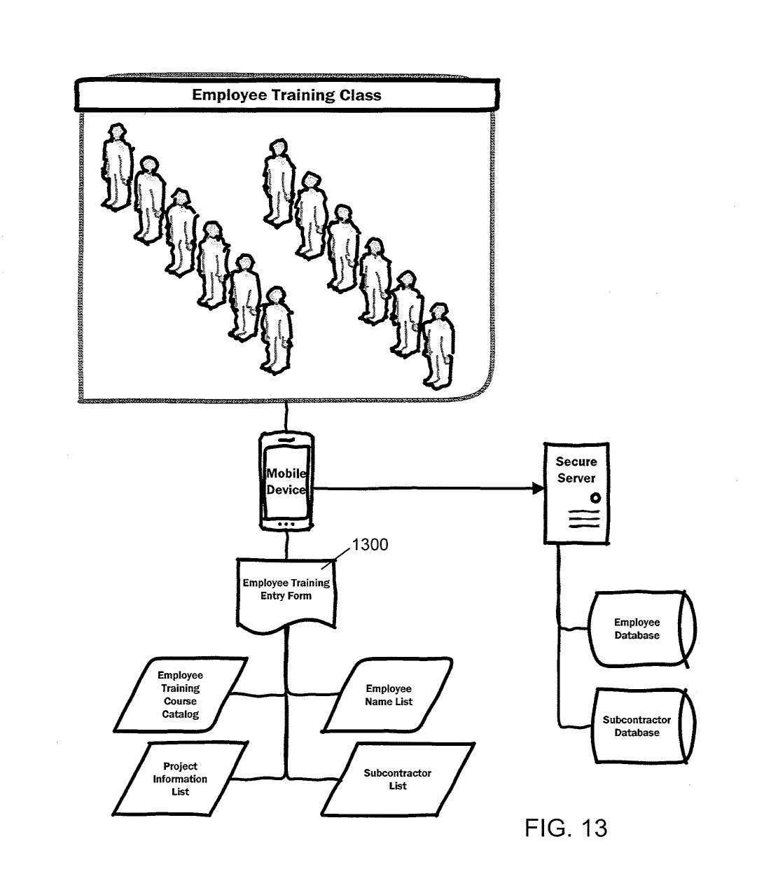

FIG. 13 illustrates an example process for providing additional training to employees. A computer or mobile device may be used to create an employee training entry form 1300. The employee entry form may include an employee training course catalog, employee name list, project information list and a subcontractor list. The employee training entry form 1300 may be saved so that a record may be maintained of which employees have received which types of training. This information may then be used by the analytics engine in an analysis of future activities and projects. Specifically, an employee already receiving training would not, unless some time has passed or a significant problem has been discovered, receive the exact same type of training again.

While the invention has been described with one construction company for ease of explanation, any number of construction companies may work together to collect and combine their data, preferably into a single database. By combining data from multiple construction companies using a standardized coding system for work activities, a much larger pool of data becomes available for the analytics engine thereby making predictions much more reliable.

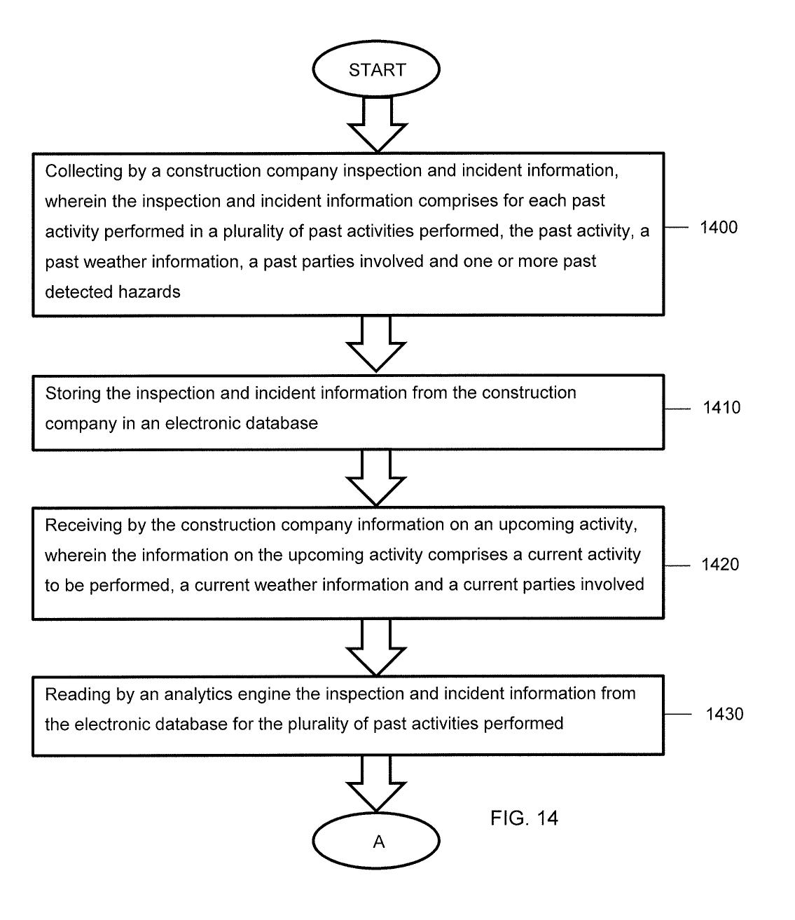

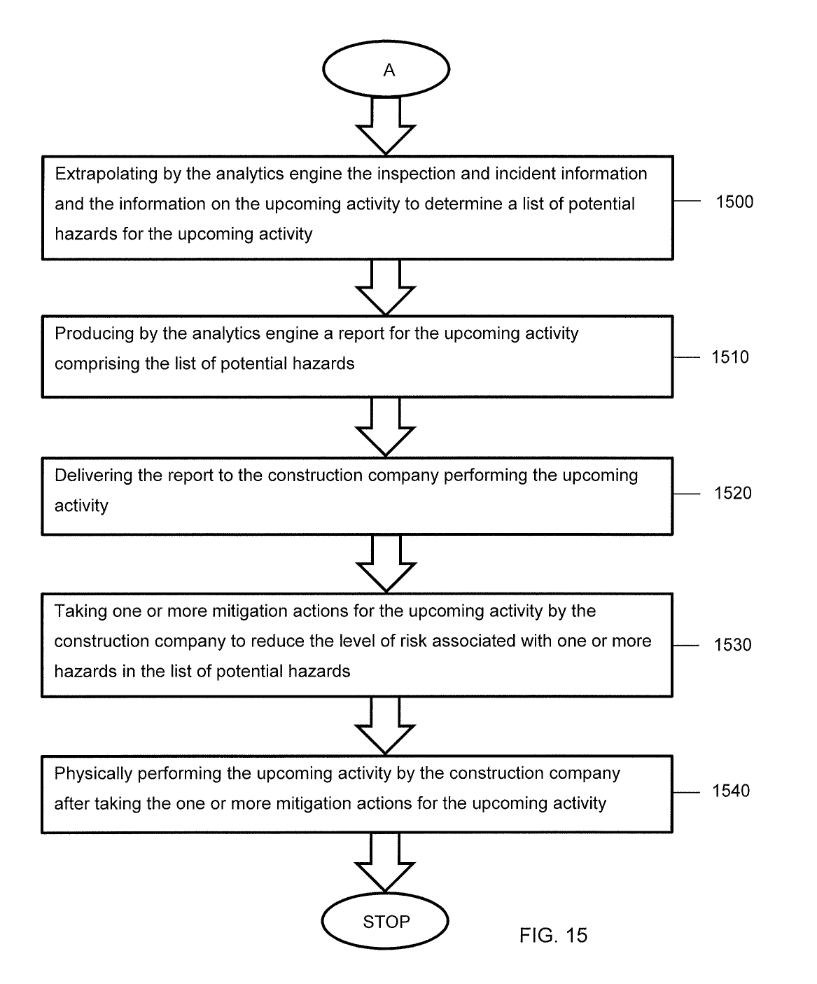

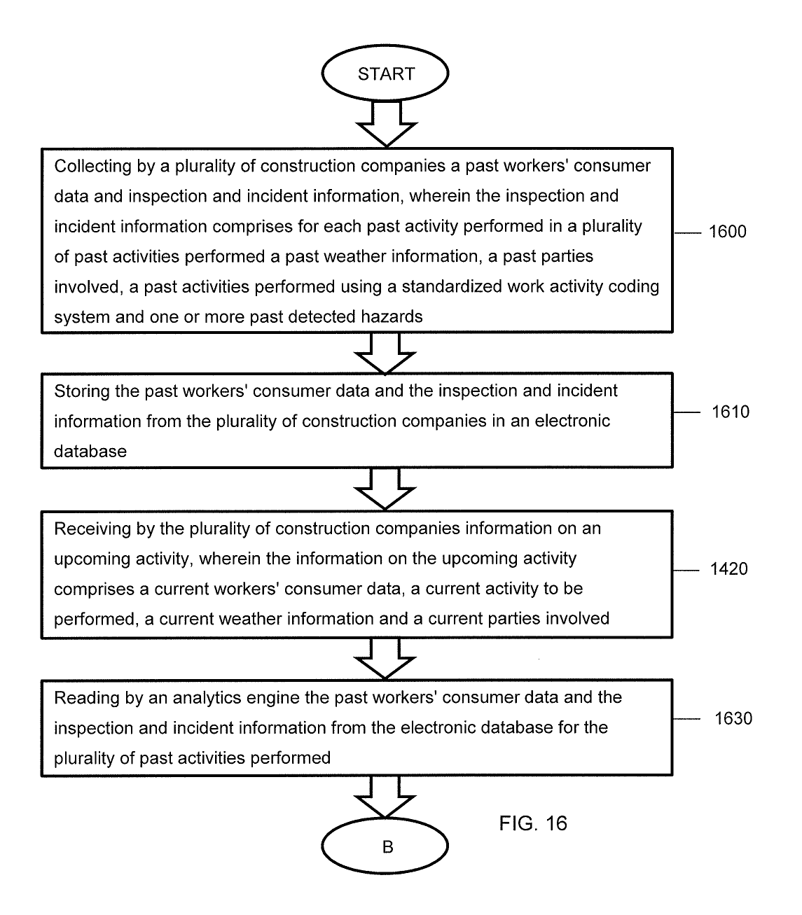

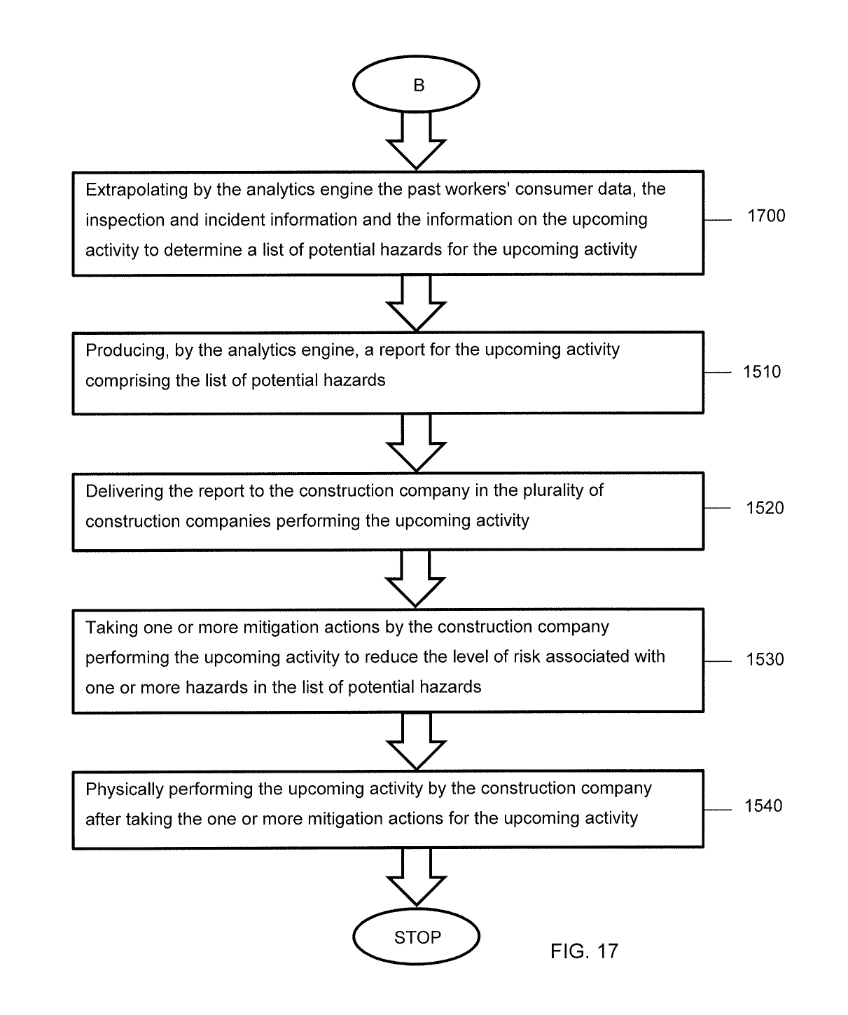

FIGS. 14-17 illustrate two non-limiting examples of flowcharts of a process for improving the safety of an upcoming activity for a construction company. Prior to the upcoming activity (and preferably for many years), a construction company may collect inspection and incident information, wherein the inspection and incident information comprises for each past activity performed in a plurality of past activities performed, the past activity 110, a past weather information, a past parties involved (worker data 120), a past working conditions 100, behavior data 130 and/or enterprise data 160 and possibly one or more past detected hazards. (Step 1400)

While the inspection and incident information may be gathered by a single construction company, a plurality of constructions companies may work together in collecting the inspection and incident information, thereby increasing the amount of data that may be processed by the analytics engine. It should be recognized that the more information used and processed by the analytics engine, the greater the predictive power of the analytics engine in predicting potential hazards that may occur while performing the upcoming activity. In addition to the inspection and incident information, the one or more construction companies may also collect past workers' consumer data, thereby providing additional information that may be processed by the analytics engine. The past workers' consumer data adds additional information regarding the workers, thereby also increasing the predictive power of the analytics engine in predicting hazards for upcoming activities. In preferred embodiments, a coding system may be implemented for all the information processed by the analytics engine so that similar events/data are processed uniformly for all past activities. As a non-limiting example, a standardized work activity coding system may be used in representing or categorizing the past activities. (Step 1600)

The inspection and incident information from the one or more construction companies may be stored in an electronic database. (Step 1410) Of course, if past workers' consumer data was also collected, then this data may also be stored in the electronic database. (Step 1610)

A construction company in the one or more construction companies may receive information on an upcoming activity. The information on the upcoming activity may comprise a current activity to be performed, a current weather information, a current parties involved, materials to be used, equipment to be used, time of the day, time of the year and workers' consumer data. (Step 1420)

An analytics engine may read the inspection and incident information from the electronic database for the plurality of past activities performed and, optionally, if collected, the past workers' consumer data. (Steps 1430 and 1630)

The analytics engine may extrapolate the inspection and incident information and the information on the upcoming activity to determine a list of potential hazards for the upcoming activity. The extrapolation may include comparing the information regarding the upcoming activity with information regarding past activities and looking for similar events, i.e., events with the same employees, employees with similar levels of experience, workers' consumer data, same or similar activity (such as laying a cement foundation), similar weather conditions (amount and type of precipitation, temperature, lighting conditions and/or wind speed), similar working materials and/or using the same or similar equipment. If an event in a past activity that is similar to the upcoming activity resulted in a hazard, i.e., an injured worker, damaged construction materials or equipment damage, the hazard(s) may be placed on a list of hazards and the combination that produced the past hazard(s) may also be listed. (Step 1500 and 1700) The analytics engine may use any type of method desired in determining one or more potential hazards for an upcoming activity. As non-limiting examples, the analytics engine may be a machine learning engine using machine learning or use artificial intelligence.

The analytics engine may produce a report for the upcoming activity comprising the list of potential hazards. In preferred embodiments, one or more suggested mitigation actions may be listed next to each hazard in the list of hazards that may be taken to reduce the risk of the hazard occurring while performing the upcoming activity. (Step 1510)

The report may be delivered to the construction company performing the upcoming activity. (Step 1520) The construction company performing the upcoming activity may take one or more mitigation actions for the upcoming activity to reduce the level of risk associated with one or more hazards in the list of potential hazards. (Step 1530) The construction company, through its employees, may physically perform the upcoming activity after taking the one or more mitigation actions for the upcoming activity. (Step 1540)

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method, comprising the steps of:
collecting by a construction company inspection and incident information, wherein the inspection and incident information comprises for each past activity performed in a plurality of past activities performed, the past activity, a past weather information, a past parties involved and one or more past detected hazards;
storing the inspection and incident information from the construction company in an electronic database;
receiving by the construction company information on an upcoming activity, wherein the information on the upcoming activity comprises a current activity to be performed, a current weather information and a current parties involved;
reading by an analytics engine the inspection and incident information from the electronic database for the plurality of past activities performed;
extrapolating by the analytics engine the inspection and incident information and the information on the upcoming activity to determine a list of potential hazards for the upcoming activity;
producing by the analytics engine a report for the upcoming activity comprising the list of potential hazards;
delivering the report to the construction company performing the upcoming activity;
taking one or more mitigation actions for the upcoming activity by the construction company to reduce the level of risk associated with one or more hazards in the list of potential hazards; and
physically performing the upcoming activity by the construction company after taking the one or more mitigation actions for the upcoming activity.

2. The method of claim 1, wherein the inspection and incident information further comprises a past project schedule status and a past project cost status.

3. The method of claim 2, wherein the information on the upcoming activity further comprises a current project schedule status and a current project cost status.

4. The method of claim 1, wherein the analytics engine uses machine learning to determine the list of potential hazards for the upcoming activity.

5. The method of claim 1, wherein the extrapolating by the analytics engine further comprises determining a correlation between one or more past detected hazards and the past weather information, the past parties involved and/or the past activities performed.

6. The method of claim 1, further comprising the step of:
upon determining a level of risk associated with the current weather information for the upcoming activity is higher than a predetermined acceptable level of risk, rescheduling the upcoming activity to a date having a predicted weather information that reduces the level of risk for the upcoming activity to a level below the predetermined acceptable level of risk.

7. The method of claim 1, wherein the report for the upcoming activity further comprises a level of risk associated with each hazard in the list of potential hazards, wherein the level of risk is a percentage of times the hazard occurred in the past when conditions were similar within a predetermined range to the information on the upcoming activity.

8. A method, comprising the steps of:
collecting by a plurality of construction companies inspection and incident information, wherein the inspection and incident information comprises for each past activity performed in a plurality of past activities performed, a past weather information, a past parties involved, a past activities performed using a standardized work activity coding system and one or more past detected hazards;
storing the inspection and incident information from the plurality of construction companies in an electronic database;
receiving by the plurality of construction companies information on an upcoming activity, wherein the information on the upcoming activity comprises a current activity to be performed, a current weather information, and a current parties involved;
reading by an analytics engine the inspection and incident information from the electronic database for the plurality of past activities performed;
extrapolating by the analytics engine the inspection and incident information and the information on the upcoming activity to determine a list of potential hazards for the upcoming activity;
producing by the analytics engine a report for the upcoming activity comprising the list of potential hazards;
delivering the report to the construction company in the plurality of construction companies performing the upcoming activity;
taking one or more mitigation actions by the construction company to reduce the level of risk associated with one or more hazards in the list of potential hazards; and
physically performing the upcoming activity by the construction company after taking the one or more mitigation actions for the upcoming activity.

9. The method of claim 8, wherein the inspection and incident information further comprises a past project schedule status and a past project cost status and the information on the upcoming activity further comprises a current project schedule status and a current project cost status.

10. The method of claim 8, wherein the analytics engine uses machine learning to determine the list of potential hazards for the upcoming activity.

11. The method of claim 8, wherein the extrapolating by the analytics engine further comprises determining a correlation between one or more past detected hazards and the past weather information, the past parties involved and/or the past activities performed.

12. The method of claim 8, further comprising the step of:
upon determining a level of risk associated with the current weather information for the upcoming activity is higher than a predetermined acceptable level of risk, rescheduling the upcoming activity to a date having a predicted weather information that reduces the level of risk for the upcoming activity to a level below the predetermined acceptable level of risk.

13. The method of claim 12, wherein the predicted weather information is obtained over the Internet from a weather information service.

14. The method of claim 8, wherein the report for the upcoming activity further comprises a level of risk associated with each hazard in the list of potential hazards, wherein the level of risk is a percentage of times the hazard occurred in the past when conditions were similar within a predetermined range to the information on the upcoming activity.

15. A method, comprising the steps of:
collecting by a plurality of construction companies a past workers' consumer data and inspection and incident information, wherein the inspection and incident information comprises for each past activity performed in a plurality of past activities performed a past weather information, a past parties involved, a past activities performed using a standardized work activity coding system and one or more past detected hazards;
storing the past workers' consumer data and the inspection and incident information from the plurality of construction companies in an electronic database;
receiving by the plurality of construction companies information on an upcoming activity, wherein the information on the upcoming activity comprises a current workers' consumer data, a current activity to be performed, a current weather information and a current parties involved;
reading by an analytics engine the past workers' consumer data and the inspection and incident information from the electronic database for the plurality of past activities performed;
extrapolating by the analytics engine the past workers' consumer data, the inspection and incident information and the information on the upcoming activity to determine a list of potential hazards for the upcoming activity;
producing, by the analytics engine, a report for the upcoming activity comprising the list of potential hazards;
delivering the report to the construction company in the plurality of construction companies performing the upcoming activity;
taking one or more mitigation actions by the construction company performing the upcoming activity to reduce the level of risk associated with one or more hazards in the list of potential hazards; and
physically performing the upcoming activity by the construction company after taking the one or more mitigation actions for the upcoming activity.

16. The method of claim 15, wherein the inspection and incident information further comprises a past project schedule status and a past project cost status and the information on the upcoming activity further comprises a current project schedule status and a current project cost status.

17. The method of claim 15, wherein the analytics engine uses machine learning to determine the list of potential hazards for the upcoming activity.

18. The method of claim 15, wherein the extrapolating by the analytics engine further comprises determining a correlation between one or more past detected hazards and the past weather information, the past parties involved and/or the past activities performed.

19. The method of claim 15, further comprising the step of:
upon determining a level of risk associated with the current weather information for the upcoming activity is higher than a predetermined acceptable level of risk, rescheduling the upcoming activity to a date having a predicted weather information that reduces the level of risk for the upcoming activity to a level below the predetermined acceptable level of risk.

20. The method of claim 15, wherein the report for the upcoming activity further comprises a level of risk associated with each hazard in the list of potential hazards, wherein the level of risk is a percentage of times the hazard occurred in the past when conditions were similar within a predetermined range to the information on the upcoming activity.
